(19) United States
(12) Patent Application Publication
(10) Pub. No.: US 2010/0170381 A1
(43) Pub. Date: Jul. 8, 2010

(54) Walking on notes - a method for learning how to read sheet music

(76) Inventor: Eugeniya Bentsman-Hilzinger, Glen Rock, NJ (US)

Correspondence Address: Eugeniya Bentsman-Hilzinger, 532 Doremus Avenue, Glen Rock, NJ, 07452, US

(21) Appl. No.: 12/319,265

(22) Filed: Jan. 5, 2009

(51) Int. Cl. G09B 15/00

(52) U.S. Cl. 84/470 R

(57) ABSTRACT

A method, which presents reading sheet music as a game in three easy steps:
first walking the melody, written as sheet music, on circles laid on top, in between, above top, and below bottom line of five lines as a sequence of up, down, skip up and down instructions from a starting position indicated by the teacher or instruction,
next is repeating the walking sequence on a music instrument from a starting position shown by the teacher or instruction,
and finally writing the walking sequence as music notes on a stave.

In the first step five lines are laid on the floor with circles positioned on, between, above top and below bottom lines. If it is more convenient, the same layout can be drawn on paper, and below instructions performed visually.

Next, the student is directed to exact position of the first circle, which corresponds to the position on a stave of the first music note of the melody written as the sheet music. The following sequence of instructions given by the teacher or music teaching book translate sheet music melody to a progression of music notes, where each new music note is relative to the previous music note as in its position above or below it on the five lines, the bottom lines being lower than the top lines. Additionally, each music note's position on or between lines (above top & below bottom lines are also considered between lines) is the key to the instruction to be used. If both music notes of the melody being read are positioned on lines, then to get from one music note to another would be to touch circles laid on top of the lines, skipping the circles positioned between lines in the up or down direction of the following note. Similarly, if both notes are positioned between lines, to get to the next music note would be to touch circles laid in between the lines, skipping the circles positioned on the lines in the up or down direction of the next note read. If consecutive music notes are adjacent to each other, meaning one music note is positioned between lines, while the other note is positioned on either bottom or top of these lines, then there is no need to skip. The instruction will be to go to the adjacent circle in the up or down direction, depending on the relative position of the music note. If consecutive music notes are not adjacent and previous music note is positioned on a line while the next one is between lines, then the instruction would be in the up or down direction of the next note to touch circles laid on lines, skipping the circles positioned between lines and step on the next circle on a line. Conversely, if consecutive music notes are not adjacent and previous music note is positioned between lines while the next one is on a line, then the instruction would be in the up or down direction of the next note, to touch circles laid between the lines, skipping the circles positioned on the lines and step on the next circle between the lines.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

1. Field of the Invention

Most music methods instruct students how to play a music instrument by teaching how to read sheet music. As shown in Figure A, the sheet music notation mostly used is simply five horizontal lines (called a stave) on which
circles with or without stems (called music notes) and
clefs (signs indicating if the music notes are high or low)
   are written. Each music note on a stave has a unique position and therefore name (alphabet letters from A to G). These music notes correspond to particular keys, valves, frets, etc. of a musical instrument. Knowing how to read sheet music is to know how to play sheet music on a music instrument.

2. Background Art

Most methods for learning how to read sheet music first teach the names of the music notes and their positions on the stave and music instrument. This is accomplished in a few steps:
first by matching letters written inside circles with the letters in that instrument's keys as illustrated in Figure B (FIG. 1 and FIG. 2). This exercise takes a few lessons.
and/or
introducing the student to the sheet music notation by matching the names of the music notes in the sheet music with the names of the keys, valves, frets, etc. of a musical instrument, i.e. a keyboard shown in Figure B (FIG. 2 and FIG. 3). Some methods additionally number every line of a stave.

For example, patent U.S. Pat. No. 5,496,179 by Hoffman, Christine describes matching music notes on a music stave with their keyboard keys by placing animal characters on both music stave and the keyboard. The focus of this method is on matching. This method takes away from reading and playing sheet music right away. First the student has to spend time matching characters. Next, when the animal characters are removed, the student might have a hard time reading sheet music without them.

Another patent U.S. Pat. No. 2,692,526 by Watson, Nora B. illustrates major & minor scales as a process of walking on a step ladder. Walking on a step ladder emphasizes the progression of pitch in an upward and downward direction and particularly teaches scales, an 8-note progression of consecutive keys. This method does not use a music stave and also enforces learning the names and positions of the notes and their corresponding music instrument's keys before reading and playing a musical piece.

### BRIEF SUMMARY OF THE INVENTION

Learning the names of music notes, their position on the music stave and their corresponding positions on the music instrument by matching makes learning how to read sheet music for most students tedious, slow and hard.

There should not be any need to learn the names of the music notes in order to read sheet music. It is not like learning how to read words when the knowledge of the alphabet letters and sounds is essential.

It would be advantageous to learn how to read sheet music as in what you see is what you play automatically, without much thinking and/or knowing what the names of the music notes are and/or where on a music instrument to locate each music note. Learning thru a familiar activity and fun motor games would father enhance the learning experience.

By using Walking on Notes method for reading, playing and writing sheet music playing sheet music is simple and instantaneous. It presents reading sheet music as walking or skipping on circles (music notes) positioned on or between lines) one or more times, up or down, starting at a position indicated by instruction. There is no need to know the names of the music notes or to match every music note on the stave with the key, valve or fret of the musical instrument. Playing simple tunes using this method makes learning music notes and musical instrument's keys, valves or frets an easy task.

Walking on Notes method for reading, playing and writing sheet music consists of one or three easy steps: walking a melody, playing it on a musical instrument, and finally writing the melody on a stave.

To walk the melody means to walk on circles positioned on and between the lines of the music stave as shown in Figure C (FIG. 4), as a series of walking and skipping instructions like Up, Down, Skip Up 2, etc. The theory behind the method is perceiving sheet music melody as a progression of music notes, where each new music note in the sheet music is relative to the previous music note by its position on a stave: above or below, and its position on the music stave: on or between lines. For example, if two consecutive music notes of the melody are both written on a line, the student would skip circle(s) between line(s) as many times as there are lines between these music notes in up or down direction of the new music note. Similar strategy applies if both music notes are between lines—student would skip the circles on the lines in up or down direction of the new music note. However, if one note is between lines and another one is positioned on one of these lines, then the notes are considered adjacent. The student would not need to skip any circles and simply step on the circle right above the one he/she is standing on in the up or down direction of the second music note. If both music notes are not adjacent, then if the first music note is on a line and the second music note is between lines, then to get to the second music note the walking instruction for the student would be to skip all the circles between the lines until the between lines circle right below the second note is touched, and then step on the adjacent circle in the up or down direction of the second music note. Similarly, if the first music note is between lines and the second music note is on a line, then to get to the second music note the walking instruction for the student would be to skip all the circles on the lines until the circle on a line right below the second music note is touched, and then step on the adjacent circle in the up or down direction of the second music note.

The up or down direction of the melody can initially be indicated by UP and DOWN signs on both the sheet music and the music instrument as shown in Figure C (FIG. 4 and FIG. 5).

If the concept of the Walking on Notes method for reading, playing and writing sheet music is understood by a student, steps two and three of the method are not necessary. The student is ready to read and play any simple melody.

Otherwise, after the melody is walked, the same sequence of steps is translated to the musical instrument. Finally the melody can be documented onto a music stave as the same sequence of steps performed by both walking and playing on the musical instrument.

Walking on Notes method for learning how to read, play and write sheet music can be easily simulated by anyone. Not having to buy any materials for learning using this method would make the method available to everyone, plus help foster creativity.

### BRIEF DESCRIPTION OF THE SEVERAL VIEWS OF THE DRAWINGS

Figure A Sheet music

Some of the elements of the sheet music notation.

Figure B Matching music notes

Matching music notes with keys of the keyboard

FIG. 1 Music notes names inside circles;

FIG. 2 Music notes names on a keyboard

Picture of a keyboard showing music note names written under it

FIG. 3 Music notes names in sheet music

Representation of music notes on a stave, listing note names.

Figure C Walking on Notes method for learning how to read, play and write sheet music

FIG. 4 Step 1—Floor layout

Upper view of the floor layout to be used in step 1 of the method.

FIG. 5 Step 2—Piano keyboard

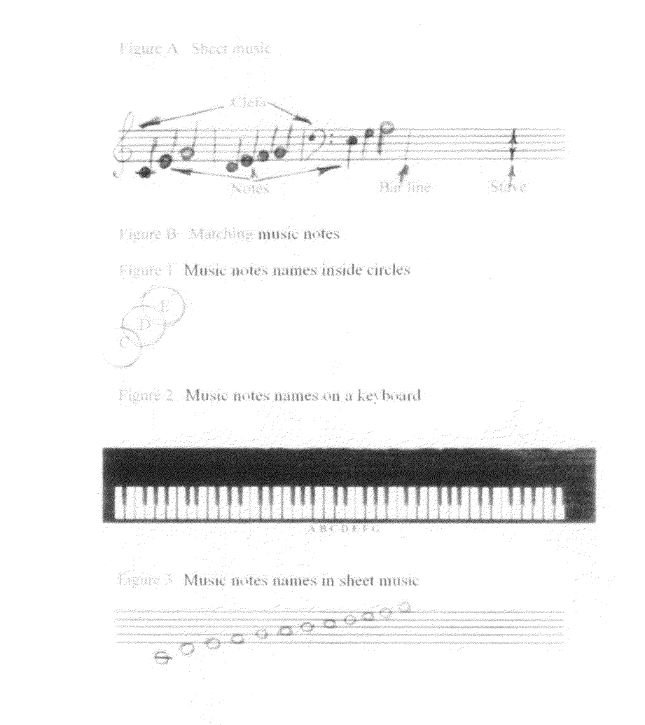

Upper view of the piano keyboard to be used in step 2 of the method.

Figure E First four bars of Mary Had a Little Lamb

Sheet music notation of the first four bars of Mary Had a Little Lamb

Figure F Music note E on a piano

Starting position for playing the first music note of Mary Had a Little Lamb.

### DETAILED DESCRIPTION OF THE INVENTION

While teaching young (5 years old and up) children how to play piano I developed fun and easy methods to help students learn how to read sheet music. My students play simple melodies in the very first lesson, having no knowledge of the music notes names or their positions on a stave and corresponding music instrument's keys.

With most music instructions beginner students play only music notes they learnt that are either next to each other or one note apart. As students learn the name and position of every music note they play, the distance between notes played increases. With Walking on Notes method for learning how to read, play and write sheet music students can play any melody right away without knowing the names or positions of the music notes or their corresponding music instrument's keys. It is not necessary.

To learn how to play a short simple music piece using the Walking on Notes method for learning how to read, play and write sheet music a teacher or instruction requires three steps.
Step 1 The student first is asked to walk or jump on circles a sequence of instructions such as Up, Down, Same, and Skip from a set position. This is done two or more times to facilitate the memorization of the instruction.
Step 2 The student repeats the sequence of steps on the music instrument from the starting position shown by the teacher or instruction.
Step 3 To make sure the student understands how to read sheet music the student has to copy the sequence of notes walked onto a music stave with or without the teacher's help.

Step 1

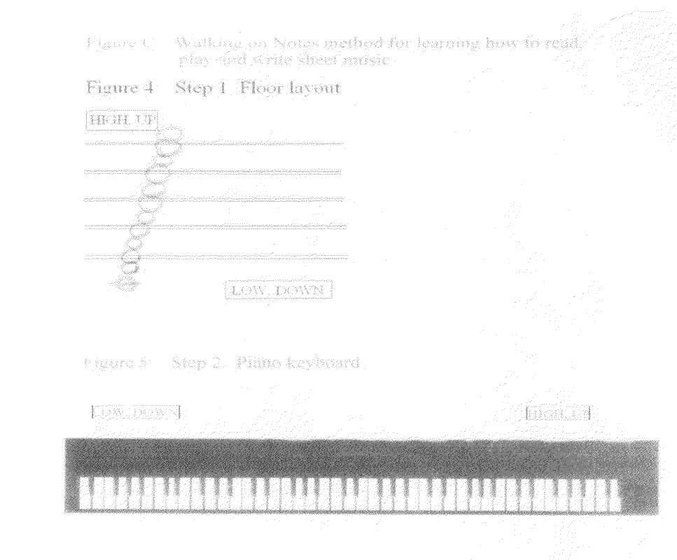

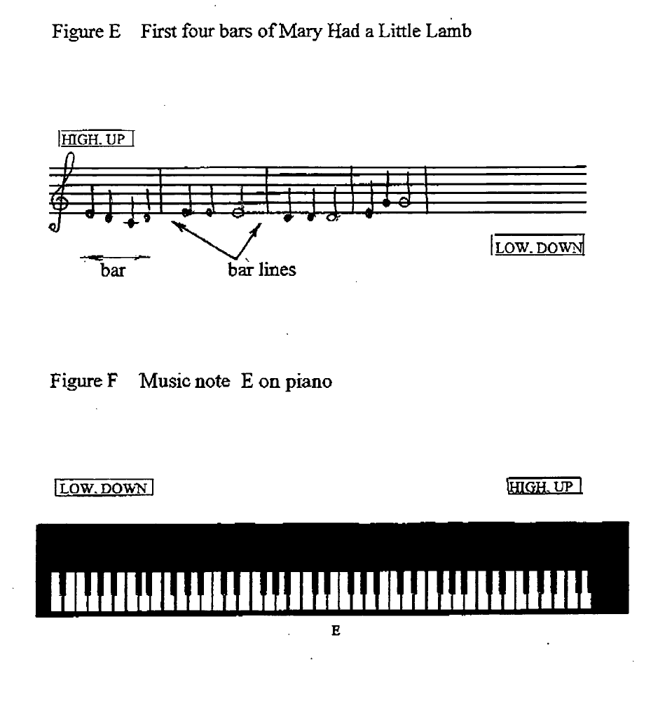

To prepare to walk any melody students set up the following layout on the floor, as illustrated in Figure C, FIG. 4.
Place five long dowels horizontally, leaving enough space in between to place the foot. This represents a music stave.
Add two signs: HIGH, UP and LOW, DOWN to distinguish the direction of the music notes. The same signs are also placed on the piano (Figure C, FIG. 5) to tie the direction of high and low music notes to the instrument's pitch sounds.
Add a short ruler on the bottom to put a middle C music note on, if desired.
Arrange paper circles first on top of dowels, and then add more circles in between. Put three more circles below the lower dowel, on the short ruler, and above the top dowel. These circles represent music notes and the core of the Walking on Notes method for learning how to read, play and write sheet music. Two circles are adjacent to each other if the circles are next to each other and one circle is on a line and another one is not.

Once the layout is completed, the student is ready to walk the melody written as sheet music. The game is for a student to walk/hop or skip circle(s) as a sequence of either up, down, skip or in place steps as directed by a teacher or instruction, starting at a given position. This step may be done two or more times to insure that the student remembers the sequence. To check if the student remembers the walking sequence the teacher might remove some or all of the circles and ask the student to walk the sequence without them.

To walk a melody means to walk on circles positioned on and between the lines of the music stave as shown in Figure C (FIG. 4), as a series of walking and skipping instructions like Up, Down, Skip Up 2, etc. The theory behind the method is perceiving sheet music melody as a progression of music notes, where each new music note in the sheet music is relative to the previous music note as above or below it on a music stave, as well as positioned on or between lines of a stave.

The student is directed to a starting position on a circle which might be on a particular line (dowel) or between lines (dowels). Then he/she follows one or more of the instructions listed below.

Up or Down instruction—if two consecutive music notes of the melody are adjacent, i.e. they are either on a line or right above or below that line. For example, every two consecutive notes in the first bar of Mary Had a Little Lamb illustrated in Figure E are adjacent The walking instruction for the student would be to step up or down on an adjacent circle without skipping any circles.

Same instruction—if two consecutive music notes of the melody are positioned the same on the music stave. The walking instruction for the student would be to step or hop in place.

Skip Up n or Skip Down n instruction. If two consecutive music notes of the melody are both written on a line, then the walking instruction for the student would be to skip circle(s) between line(s) as many times as there are lines between these music notes plus one (n) in the up or down direction of the second music note. Similar strategy applies if both music notes are between lines—student would skip the circles on the lines in the up or down direction of the second music note.

Skip Up n & Up or Skip Down n & Down instructions combines two instructions each for both notes not similarly positioned on a music stave as in Skip Up n and Skip Down n instructions. If one note is between lines and another one is positioned on one of these lines, then the notes are considered adjacent. The student would not need to skip any circles and simply step on the circle right above the one he/she is standing on in the up or down direction of the second music note. However, if music notes are not adjacent, then if the first music note is on a line and the second music note is between lines, then to get to the second music note the walking instruction for the student would be to skip all the circles between the lines until the between lines circle right below the second note is touched, and then step on the adjacent circle in the up or down direction of the second music note. Similarly, if the first music note is between lines and the second music note is on a line, then to get to the second music note the walking instruction for the student would be to skip all the circles on the lines until the circle on a line right below the second note is touched, and then step on the adjacent circle in the up or down direction of the second music note.

Step 2

The student is then asked to repeat the sequence of instructions in step 1 on the music instrument. As in step 1 all the teacher is required to do is show the student which key on the music instrument represents the starting position of the game.

To insure the comprehension of the Skip instructions, Steps 1 & 2 can be repeated a few times followed by removal of the in-between circles in step 1.

Step 3

The final step is for the student to copy the steps performed on the floor onto the sheet music to play any time with or without the help of the teacher. This in effect is the melody just played written as a sheet music.

Once the student is comfortable with this exercise, reading sheet music becomes easy. Learning music notation, simple songs or creating new ones using this method is instantaneous.

### EXAMPLE

To learn how to play piano the first four bars (music notes separated by a clef and a bar line (a vertical line), or bar lines) of Mary Had a little Lamb song as illustrated in Figure E, in 3 steps described above:

Step 1 Walk the sequence of the following instructions on circles of the floor layout shown in Figure C.

Step on the circle on top of the bottom dowel, Down, Down, Up, Up, Same, Same, Down, Same, Same, Up, Skip Up 1, Same.

Step 2 Play the tune on the piano.

Find the starting position on the piano, as illustrated in Figure F:

Find a group of two black keys in the middle of the piano. Key E is a white note following the black note that is on the side of the “HIGH, UP” sign.

Perform the sequence of the walking steps in Step 1 above starting at E: play E, Down, Down, Up, Up, Same, Same, Down, Same, Same, Up, Skip Up 1, Same.

Step 3 Copy down the music played.

A teacher or a student copies the sequence of circles stepped on in step 1 onto a hand-drawn music stave (for a better hands-on comprehension) and adds two signs: HIGH, UP and LOW, DOWN on top and the bottom of the stave respectively (Figure E). Even though the stave has no circles on it anymore, the student will remember the rules described in Step 1. This step may be reserved for later for the younger students to make sure they comprehend the rules of step 1.

This is all that is required initially to make the student comfortable reading sheet music.

Learning music notes names using this method is very easy. Alphabet letters can be pronounced or even sung in all steps of the method. For example, in the above example of Mary Had a Little Lamb four notes names can be easily learned: C, D, E and G, if the student so wishes. The student would sing the following alphabet letters while performing each step: E, D, C, D, E, E, E, D, D, D, E, G, G. However, it is not necessary to know these names in order to be able to play the song.

Walking on Notes method for learning how to read, write and play sheet music enhances memory and creativity. Students memorize a sequence of steps to play the melody. By experimenting with different sequences of stepping on music notes a student can create new tunes.

Walking on Notes method for learning how to read, play and write sheet music can be implemented with different materials by students and/or teachers.

Walking on Notes Mat

The Walking on Notes mat can be made of felt fabric, preferably of a bright color that kids like, with a different color Velcro stripes representing music stave and Velcro circles representing music notes. These materials should not exclude any other ways of embodying the mat. For example, it can be made of foam, rubber, be a puzzle, etc. It would be helpful if the mat had a slight elevation to give it a feeling of music notes going up.

While the preferred embodiment of the invention has been described, modifications can be made and other embodiments may be devised without departing from the spirit of the invention and the scope of the appended claim.

1. A method for learning how to play, write and read sheet music, which comprises the steps of
moves on music notes positioned on, between, above or below the lines,
wherein said moves can be a group of activities consisting essentially of stepping, jumping, walking, skipping, reading in your mind, and finger “walking”,
whereas said lines can be a group of objects consisting essentially of anything that the moves can be done upon and would look like lines,
whereas said lines comprise five lines,
whereas
Adjacent music notes are two consecutive music notes where either the previous music note is on a line and the next music note is right above or below that line, or visa versa, the previous music note is between lines and the next music note is either on a line right above or right below that music note,
whereas
a higher music note is positioned above the previous music note on the lines,
whereas
a lower music note is positioned below the previous music note on the lines,
whereas said moves is a sequence of instructions consisting essentially of a move from a music note to a music note and can be:
Up, if both music notes are adjacent and this music note is higher,
Down, if both music notes are adjacent and this music note is lower,
Same, if both music notes are positioned the same on the music stave,
Skip Up n, if both music notes are either positioned on a line or between lines on the music stave and the second music note is higher,
Where n is a number of lines or in-between spaces on a music stave it takes to get from one note to another,
Skip Down n, if both music notes are either positioned on a line or between lines on the music stave and the second note is lower,
Skip Up n & Up combines two instructions: Skip Up n and Up, if one of the music notes is positioned on a line while another music note is positioned between the lines and the second music note is higher,
Skip Down n & Down combines two instructions: Skip Down n and Down, if one of the music notes is positioned on a line while another music note is positioned between the lines and the second note is lower,
Exact position of the first music note is indicated as the first instruction
playing the sequence of moves on a musical instrument from the position shown by the teacher or instruction,
writing the said moves onto sheet lines,
wherein said sheet lines comprise five lines,
whereby said writing can be a group of activities consisting essentially of writing and putting magnetic pieces on the sheet lines.
